(19) United States
(12) Patent Application Publication
(10) Pub. No.: US 2013/0332326 A1
(43) Pub. Date: Dec. 12, 2013

(54) BLIND ETF WITH SMALL LOT REDEMPTION TRIGGER

(71) Applicants: Noel Archard, Ardmore, PA (US); Dariusz Wojnar, Moraga, CA (US); Tony Kelly, Alamo, CA (US); Leland Clemons, Mill Valley, CA (US)

(72) Inventors: Noel Archard, Ardmore, PA (US); Dariusz Wojnar, Moraga, CA (US); Tony Kelly, Alamo, CA (US); Leland Clemons, Mill Valley, CA (US)

(73) Assignee: BLACKROCK INSTITUTIONAL TRUST COMPANY, N.A., San Francisco, CA (US)

(21) Appl. No.: 13/491,512

(22) Filed: Jun. 7, 2012

(51) Int. Cl. G06Q 40/04

(52) U.S. Cl. 705/37

(57) ABSTRACT

To protect individual investors in a blind Exchange Traded Fund (ETF) from being disadvantaged compared to the Authorized participants (APs), a mechanism is provided to enable small lot redemptions at the ETF's Net Asset Value (NAV) price under certain conditions. The market price and NAV price for the ETF are monitored and if one or more threshold conditions are detected, a trigger event is determined to have occurred. When a trigger event occurs, individual investors are notified of an option to redeem small lots of ETF shares. If the option is exercised, the individual investors are paid for shares redeemed at the NAV price rather than the market price.

### BACKGROUND

This invention relates generally to financial services and products, and more particularly to financial systems for trading a blind exchange traded fund (ETF), which does not provide visibility to the holdings of the ETF.

Large institutional investors known as authorized participants (APs) buy and sell shares of an ETF in large fixed size blocks, known as creation units. These transactions occur in a primary market at a price determined by the net asset value (NAV). The NAV price for an ETF is defined as the total value of assets held by the ETF divided by the number of shares. In contrast, individual investors access the ETF by trading shares in a secondary market, typically in much smaller quantities than a creation unit.

The market price for shares of an ETF in the secondary market is determined by market forces, and thus varies from the ETF's NAV price. Shares in the secondary market can sell for more than the NAV price (at a premium) or less than the NAV price (at a discount). Under certain circumstances, it is possible that the shares of the ETF will be consistently discounted in the secondary market. As a result, individual investors may be at a disadvantage as compared to the APs, as the APs always have the ability to redeem shares at the NAV price.

It would therefore be advantageous to individual investors to provide a mechanism enabling them to sell shares at the NAV price if the share price remains significantly discounted in the secondary market for a significant period of time.

### SUMMARY OF THE INVENTION

In accordance with embodiments, methods for managing a blind ETF provide mechanisms to protect individual investors from being disadvantaged as compared to institutional investors when the market price of ETF shares run at a discount when compared to the NAV price. In one embodiment, a mechanism to provide individual investors with an option to redeem small lots of ETF shares at the NAV price is triggered on detection of a predetermined set of conditions, such as the market price being below a threshold discount percentage for a particular period of time. When triggered, the mechanism notifies individual investors of their right to redeem their shares of the ETF at the NAV value. If an investor exercises the option to redeem a small lot redemption of the investor's ETF shares, the proceeds of this redemption are then delivered to the investor, possibly less fees. In some embodiments, the small lot redemption is implemented via a custodian. Although embodiments of the invention are described in connection with a blind ETF, embodiments of the invention may be applied to other types of funds or products.

### BRIEF DESCRIPTIONS OF THE DRAWINGS

FIG. 1 is a high level diagram illustrating a creation process for a blind ETF, in accordance with an embodiment of the invention.

FIG. 2 is a high level diagram illustrating a redemption process for a blind ETF, including a triggerable small lot redemption option, in accordance with an embodiment of the invention.

FIG. 3 is a high level diagram illustrating a small lot redemption process for an ETF, in accordance with an embodiment of the invention.

FIG. 4 is a block diagram illustrating an example of a computer for use by an authorized participant, a central intermediary, an individual investor, or in a management facility of the ETF.

### DETAILED DESCRIPTION

Investors commonly invest in different types of investment funds and financial products to gain exposure to various types of assets, including stocks, bonds, commodities and derivatives. A very popular type of fund is an exchange traded fund (ETF). Other exchange traded vehicles have also emerged over the years, such as exchange traded grantor trusts that behave similarly to ETFs. All such vehicles within this wider class are typically referred to as exchange traded products, or ETPs. Shares of an ETP are securities that represent a legal right of ownership or beneficial interest in an underlying portfolio of securities or other assets held by the issuing fund/product, as applicable. The assets held by an ETP may include individual stocks, bonds, cash, commodities, derivatives, or any other tradable asset, including contracts based on the value of any of the foregoing.

Shares of an ETP are designed to be listed on a securities exchange and traded over the exchange just like other securities. ETPs thus allow an investor to own an undivided proportionate interest in the assets held by the ETP by simply purchasing shares of the individual ETP. Many existing ETPs hold a mix of assets that aim to replicate or otherwise match the characteristics of a particular published index. These ETPs allow investors to have exposure to the index by purchasing shares of the single ETP. Other existing ETPs seek to provide exposure to commodities (such as gold, silver, oil and gas), a portfolio of currencies or futures contracts and may or may not track an index or benchmark. Because of their low cost and tax advantages, ETPs have grown in popularity in recent years.

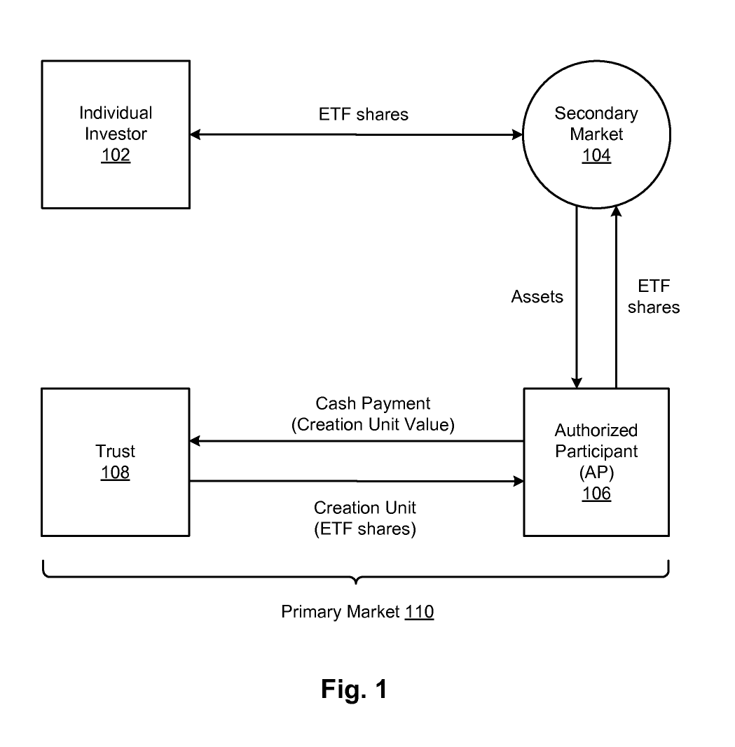

FIG. 1 illustrates a simplified share creation process for an ETF (or “trust”) in a primary market 110 in accordance with one embodiment. The ETF shares are generally made available to investors 102 through a two-tiered market structure, which includes the primary market 110 and a secondary market 104. In the primary market 110, issuance of new shares of the ETF can be created only in multiples of a minimum block of shares (“creation units”). Because of the large size of the minimum creation units required for purchases of new ETF shares, these shares are generally only available in the primary market 110 to certain institutional investors, known as authorized participants (APs) 106. APs 106 are typically large institutional broker dealers or market makers that transact directly with an ETF for purchases of creation units of the ETF shares at the end of day net asset value (NAV) of the ETF.

In general, the consideration for purchase of a creation unit of an ETF comprises a deposit of a predefined basket of assets in exchange for a creation unit of shares of the ETF issued by a trust 108 to the AP 106. In the illustrated embodiment, the trust 108 represents a blind ETF. In contrast to a conventional ETF, which publishes its held assets each day, the assets held by the blind ETF are kept secret, and only the NAV (and hence value of a creation unit) and intra-day real-time value of the trust (IVV) are published each day. In the illustrated embodiment, the AP 106 makes a cash payment equaling the value of one creation unit. The cash value of a creation unit is determined each day using the trust's 108 NAV for that day. The cash is then used to purchase the assets that the trust 108 desires to hold, based on factors such as a specified investment strategy, and current asset prices. In an alternative embodiment, the cash payment is made to an intermediary (not shown) that is aware of the assets the trust 108 desires in exchange for a creation unit of shares. The intermediary then purchases the required assets and transfers them to the trust 108, taking a small commission or other fee for providing the service.

The trust 108 may be managed or unmanaged in different embodiments. In one embodiment where the trust 108 is unmanaged, the blind ETF defines a basket of assets that are required for a creation unit of shares to be issued, much like a conventional ETF. However, unlike with conventional ETFs where the basket is published daily as part of a portfolio, the assets included in the basket remain secret from investors, and are known only to the trust 108. In another embodiment, where the trust 108 is managed, a fund manager uses the cash payments received from APs 106 to purchase assets at their own discretion, based on factors such as a specified investment strategy, a tracked market index, and current asset prices.

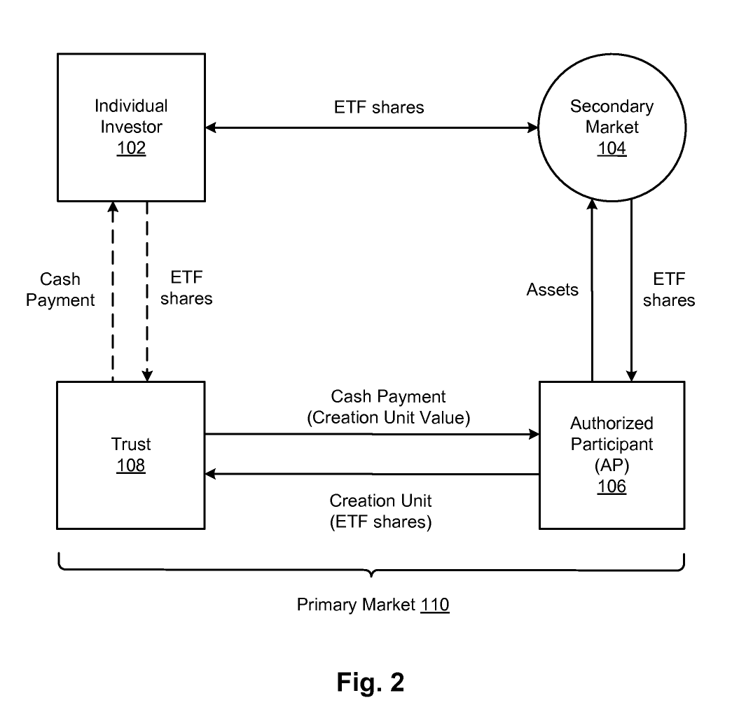

The opposite process occurs for a redemption of ETF shares, as shown in FIG. 2. In one embodiment, an AP 106 can redeem shares of a blind ETF by delivering a block of the shares (e.g., the same size block as in a creation unit) to the trust 108. In exchange, the trust 108 makes a cash payment equivalent to the value of the shares, as determined by that day's NAV.

In contrast to the primary market 110, in which APs 106 may transact for the creation or redemption of creation size units of an ETF, individual investors 102 can usually access the shares only in a secondary market 104. Once the block of the shares in the creation size units is received by the AP 106, the shares may be broken down into less than creation unit sizes (including individual shares) and sold by the AP 106 directly to customers or over a secondary market 104, where individual investors 102 may buy and sell shares of the ETF through their brokerage accounts. An intermediary, such as a broker/dealer or financial advisor, may advise investors 102 directly and recommend and sell the shares. Conversely an AP 106 may obtain the assets or shares required for a creation/redemption in the primary market 110 by trading in the secondary market 104.

Under normal conditions, individual investors 102 may sell shares only in the secondary market 104, and hence the price they can obtain is determined by market forces. In contrast, the price that the AP 106 can redeem shares for is tied to the NAV, which is the value of the trust's 108 held assets. However, if specific conditions are met (known as a “trigger event”), the individual investors 102 are given an opportunity to redeem shares at the NAV price, as illustrated by the dotted arrows in FIG. 2.

The difference between the NAV price and the share price in the secondary market 104 is monitored daily. In some embodiments, the share price is considered to be the midpoint between the ask and bid prices for the shares at close of business on that day. In other embodiments, different methods for calculating the share price for the day are used, e.g., an average of the price in all purchase and sales of the shares over the business day.

In one embodiment, a trigger event is determined to have occurred when the monitored secondary market share price is discounted by more than a threshold amount for more than a threshold period of time, when compared with the NAV price over the same period of time. For example, if a discount of 5% or greater is observed for 10 consecutive business days, a trigger event will occur at the end of the tenth business day. In other embodiments, other trigger events are used.

Once a trigger event has been detected, a small lot redemption window opens. In one embodiment, a small lot redemption window begins on the business day after the trigger event and remains open for 30 calendar days. When the small lot redemption window opens, individual investors 102 are notified. Depending on the environment and specific embodiment, different notification methods are used. In one embodiment, three parallel methods of notification are utilized. First, the trust 108 publishes a notification on a website maintained by the trust; second, the trust 108 issues a press release to financial media outlets; and third, notification is issued through the Depository Trust Company (DTC). The DTC notifies brokers and dealers in the secondary market 104 of the trigger event and the fact that a small lot redemption window is opening. The brokers and dealers in-turn notify affected individual investors 102 through their existing channels of communication, such as email, telephone, and SMS text message.

While the small lot redemption window is open, individual investors 102 are able to redeem shares in less than creation unit size batches at the NAV price rate that is normally only available to APs 106 in the primary market 110. An individual investor 102 requests a redemption for some or all of the shares they own via their usual broker or dealer in the secondary market 104. In one embodiment, a small lot redemption processing fee is charged (e.g., 2% of the total redeemed value). In a related embodiment, the brokers and dealers aggregate redemption requests received from individual investors 102 throughout the period during which the small lot redemption window is open in order to reduce the total number of redeem transactions required with the trust 108. In a further related embodiment, small lot redemptions processed in this manner can only be for less than one creation unit's worth of shares.

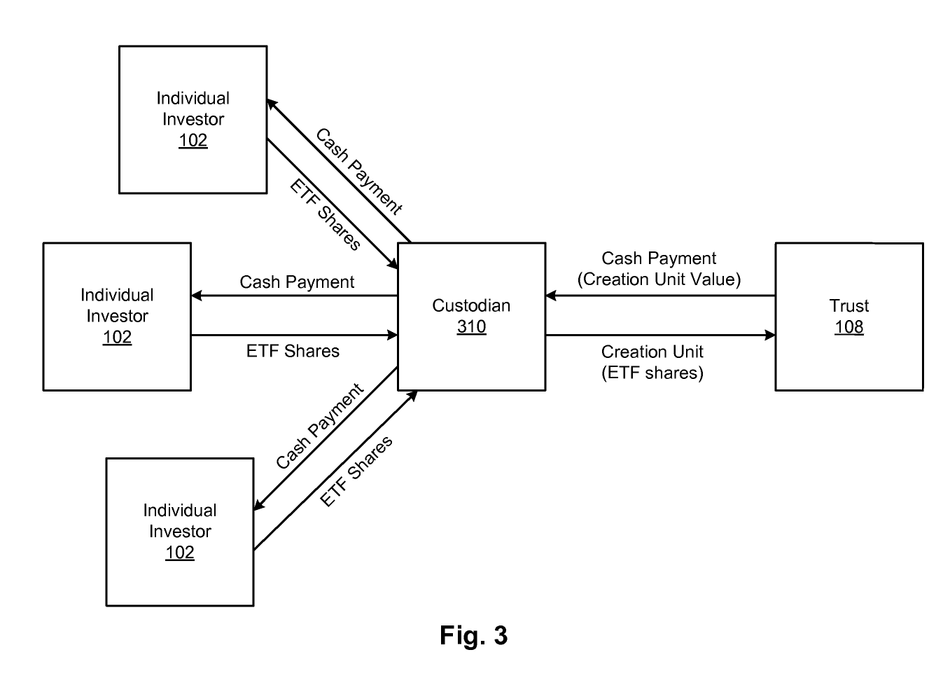

In one embodiment, as shown in FIG. 3, a custodian 310 is used to manage the small lot redemptions. The custodian 310 is a specialized AP 106 that has an agreement with the trust 108 to aggregate shares redeemed via small lot redemption. Individual investors redeem shares for cash payments with the custodian 310 during one or more small lot redemption windows. When the custodian 310 has amassed enough shares to make a creation unit sized redemption in the primary market 110, it does so. Thus, the trust 108 is shielded from the expenses associated with maintaining the facilities required to implement transactions with individual investors 102.

If after the small lot redemption window closes, the trigger event conditions are still met (e.g., if for the last 10 business days of the small lot redemption window the secondary market value of shares remains 5% or greater below the NAV price of the trust 108), then a second small lot redemption window will immediately open on the following business day.

Where in the above description the trust 108 initiates a transaction or otherwise acts, this is administered by a management facility. In one embodiment, the management facility is one or more computer systems of one or more trustees who manage the day to day operation of the trust 108. In another embodiment these actions are entirely automated by one or more computer systems programmed for the management of the trust 108. The computers that comprise such a management facility may be at a centralized location, or may be at geographically remote locations and communicatively coupled via a network.

Process flows and systems for trading ETFs are described in more detail in U.S. Pat. No. 7,937,316 and U.S. Patent Publication No. 2010/0174664, filed Jan. 4, 2010, each of which is incorporated by reference in its entirety.

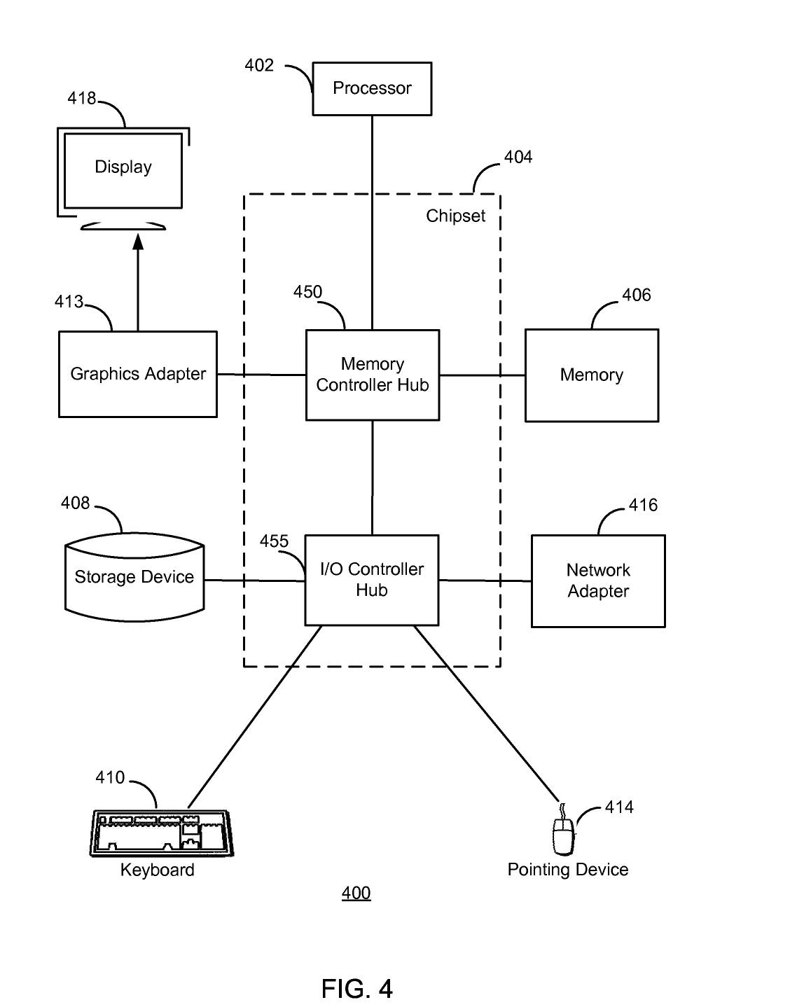

FIG. 4 is a high-level block diagram illustrating an example of a computer 400 for use by an AP 106, the central intermediary 112 or investors 102, or as part of a management facility for the trust, in accordance with embodiments of the invention. Illustrated are at least one processor 402 coupled to a chipset 404. The chipset 404 includes a memory controller hub 450 and an input/output (I/O) controller hub 455. A memory 406 and a graphics adapter 413 are coupled to the memory controller hub 450, and a display device 418 is coupled to the graphics adapter 413. A storage device 408, keyboard 410, pointing device 414, and network adapter 416 are coupled to the I/O controller hub 455. Other embodiments of the computer 300 have different architectures. For example, the memory 406 is directly coupled to the processor 402 in some embodiments.

The storage device 408 is a computer-readable storage medium such as a hard drive, compact disk read-only memory (CD-ROM), DVD, or a solid-state memory device. The memory 406 holds instructions and data used by the processor 402. The pointing device 414 is a mouse, track ball, or other type of pointing device, and in some embodiments is used in combination with the keyboard 410 to input data into the computer system 400. The graphics adapter 413 displays images and other information on the display device 418. In some embodiments, the display device 418 includes a touch screen capability for receiving user input and selections. The network adapter 416 couples the computer system 400 to the network 401. Some embodiments of the computer 400 have different and/or other components than those shown in FIG. 4.

The computer 400 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 408, loaded into the memory 406, and executed by the processor 402.

The types of computers 400 used by the entities of FIGS. 1 through 3 can vary depending upon the embodiment and the processing power used by the entity. For example, a fund manager working for a trust 108 may use a desktop PC, whereas an investor 102 may enter investment decision on a portable device with a small display 418 with touch screen capabilities but lack a keyboard 410 or pointing device 414.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, the techniques described herein have been described as applied to a blind ETF. The method may equally be applied to other financial instruments, possibly those not yet created, where shares of the instrument are traded and are based on an underlying set of tradable securities or other assets.

Where specific time frames have been referenced, these represent current best practice with regards to regulation and market expectations. Such time frames should not be considered limiting and are presented purely to illustrate how the current invention can be implemented in current financial markets.

Some portions of this description describe the embodiments of the invention in terms of algorithms and symbolic representations of operations on information. These algorithmic descriptions and representations are commonly used by those skilled in the art to convey the substance of their work effectively to others skilled in the art. These operations, while described functionally, computationally, or logically, may be understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Such a computer program may be stored in a tangible computer readable storage medium or any type of media suitable for storing electronic instructions. Embodiments of the invention may also relate to an apparatus for performing the operations described herein. This apparatus may be specially constructed for the required purposes, and/or it may comprise a general-purpose computing device selectively activated or reconfigured by a computer program stored in the computer.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

1. A method for managing a blind exchange traded fund (ETF), the method comprising:
monitoring a market price per share and a Net Asset Value (NAV) price of the blind ETF over time, where the blind ETF does not publish the holdings of the blind ETF;
detecting a trigger event, using a computer processor, wherein the trigger event occurs when the market price of the ETF is lower than the NAV price of the ETF for a threshold condition; and
responsive to the trigger event, sending a notification of an option to redeem a small lot of shares of the ETF at a price.

2. The method of claim 1, wherein the price is the NAV price.

3. The method of claim 1, wherein the price is the next day's NAV price.

4. The method of claim 1, wherein the threshold condition includes the market price being at least 5% lower than the NAV price.

5. The method of claim 1, wherein the threshold condition includes the market price being lower than the NAV price for at least 10 consecutive business days.

6. The method of claim 1, wherein the threshold condition includes the market price being at least 5% lower than the NAV price for at least 10 consecutive business days.

7. The method of claim 1, wherein sending the notification comprises sending a message via a Depository Trust Company (DTC).

8. The method of claim 1, wherein sending the notification comprises publishing a notification on a website.

9. The method of claim 1, wherein sending the notification comprises issuing a press release.

10. The method of claim 1, further comprising:
receiving a request from the investor to redeem a number of shares of the ETF at the price, the number of shares being less than a creation unit of the ETF;
receiving the number of shares from the investor; and
transferring value corresponding to the number of shares at the price to the investor.

11. The method of claim 1, wherein the investor redeems a number of shares of the ETF at the price with a custodian.

12. The method of claim 11, further comprising the custodian redeeming a creation unit of shares of the ETF with the ETF at the NAV price.

13. The method of claim 1, wherein the option is available for a predetermined length of time after the trigger event.

14. The method of claim 13, wherein the length of time is 30 calendar days.

15. The method of claim 1, wherein the option is available as long as the threshold condition is met, and thereafter the option expires.

16. A method for administering a blind ETF, the method comprising:
publishing a value of a creation unit of shares;
receiving, at a computing system, a request for the creation unit of shares from an investor;
receiving a transfer of the published value from the investor;
issuing a creation unit of shares to the investor; and
using the received value to obtain assets, the assets purchased not being published.

17. A method for redeeming small lots of shares of an ETF using a custodian, the method comprising:
receiving small lots of shares of the ETF from investors by a custodian, the small lots comprising less shares than a creation unit;
transferring value to the investors by the custodian, the value transferred to each investor determined by a corresponding number of shares received from the investor and a NAV of the ETF; and
redeeming a creation unit of shares of the ETF with the ETF at the NAV price.

18. The method of claim 17, wherein the value transferred to each investor is determined by multiplying the corresponding number of shares by the NAV.

19. The method of claim 17, wherein the value transferred to each investor is determined by multiplying the corresponding number of shares by the NAV and subtracting a fee.

20. The method of claim 19, wherein the fee is 2% of the total redeemed value.
